(19) United States
(12) Patent Application Publication
(10) Pub. No.: US 2004/0157703 A1
(43) Pub. Date: Aug. 12, 2004

(54) Motor driven traction vehicle

(76) Inventors: Anders Eriksson, Goteborg (SE); Lars Karlsson, Goteborg (SE); Marcus Steen, Angered (SE)

Correspondence Address: YOUNG & THOMPSON, 745 SOUTH 23RD STREET 2ND FLOOR, ARLINGTON, VA, 22202

(21) Appl. No.: 10/475,976

(22) PCT Filed: Apr. 25, 2002
(86) PCT No.: PCT/SE02/00810

(30) Foreign Application Priority Data
Apr. 27, 2001 (SE) 0101495-0

(51) Int. Cl. F16H 59/64; F16H 59/72

(52) U.S. Cl. 477/98

(57) ABSTRACT

Motor-driven tractor vehicle with an automatic clutch and gearbox between the engine and the vehicle drive wheels, and with means (6, 8; 20) which, after the vehicle has been stopped, can identify whether a load carrier (2, 11) has been attached or detached. The gearbox and the clutch are controlled by an electronic control unit (19) on the basis of a set position of a manual gear selector. The control unit is arranged, with the gear selector in the position for automatic shifting, to select, at starting off, a starting-off gear, which is determined by a first gear selection strategy stored in the control unit on the basis of information stored in the control unit on rig weight, road grade, rolling resistance, etc. The control unit is disposed at start, at least after the indication that a load carrier has been decoupled, to select the starting-off gear in accordance with a second gear selection strategy. In this case the gear selection in accordance with the second gear selection strategy involves a selection of a starting-off gear of higher ratio than the gear selection in accordance with the first gear selection strategy.

The present invention relates to a motor driven tractor vehicle with an automatic clutch and transmission between the engine and the drive wheels of the vehicle, comprising an electronic control unit for controlling the engine, means which, directly or indirectly, can identify whether a load carrier has been coupled or decoupled, an electronic control unit for controlling the transmission and the clutch depending on the set position of a manual gear selector, said control unit being arranged, when the gear selector is in the position for automatic shifting, to select, for starting off, a starting-off gear, which is determined by a first gear selection strategy stored in the control unit on the basis of various control parameters fed into the control unit.

In tractor vehicles of this type, the gear selector, in addition to an automatic position, also has other positions for each gear so that the driver can manually select which gear he wishes to start off in. When the driver puts the gear selector in the automatic position, the transmission control unit normally selects the starting-off gear with consideration to trailer weight, road inclination, rolling resistance, etc. The starting-off gear is selected with an aim to optimum fuel economy and so that the slippage in the clutch will not exceed a predetermined period of time at a given trailer weight and road grade. This can also involve a gear selector strategy, whereby a loaded vehicle normally starts off in first gear and high split, depending on said parameters. Under certain conditions, however, there can be reason to select a lower gear than that which the stored gear selector strategy in the transmission control unit would select in the automatic shift position. This is particularly the case when attaching or detaching a load carrier. For example, better maneuverability of a truck moving in towards a trailer during attachment. It also provides safer detachment of a semi-tractor from a semi-trailer at low speed with a lower gear than first gear and high split, e.g. first gear and low split or a crawl gear with a higher ratio than first gear. The driver can then, instead of the automatic position, set the gear selector to the position for the desired gear, e.g. the crawl gear position.

The purpose of the present invention is to achieve a motor-driven tractor vehicle of the type described by way of introduction which eliminates the need for manual selection of another starting-off gear than what said gear selection strategy prescribes in view of said control parameters, at least in conjunction with detachment of a trailer.

This is achieved according to the invention by virtue of the fact that the transmission control unit is arranged at starting off, at least after an indication that the load carrier has been detached, to select a starting-off gear which is determined by a second gear selection strategy stored in the control unit.

If the first gear selector strategy, in view of the given preconditions, should select first gear as a starting off gear with a load carrier attached, the second gear selector strategy with the same preconditions but with a detached load carrier, can for example select a crawl gear. The signal that the load carrier has been detached can be sent directly to the control unit when the electric connector between the tractor and the load carrier is decoupled. Return to gear selection according to the first gear selection strategy can occur after the vehicle has been driven a predetermined distance, e.g. ten meters, after decoupling of the connector.

In a preferred embodiment of a tractor vehicle according to the invention with switchable air suspension and with a control for manual setting of the suspension, which can be switched between a first driving position and a second position for adjusting the suspension, the transmission control unit is disposed to select the first gear selection strategy when the suspension control is in the first position, and the second gear selection strategy when the suspension control is in the second position. When the driver sets the suspension control in the second position to lower or raise the tractor, this is an indirect indication that a load carrier will be attached or detached and the transmission control unit will then select the second gear selection strategy for selecting a starting-off gear.

The invention will be described in more detail below with reference to examples shown in the accompanying drawings, where

FIG. 1 shows a schematic side view of a semi-tractor with a detached semi-trailer,

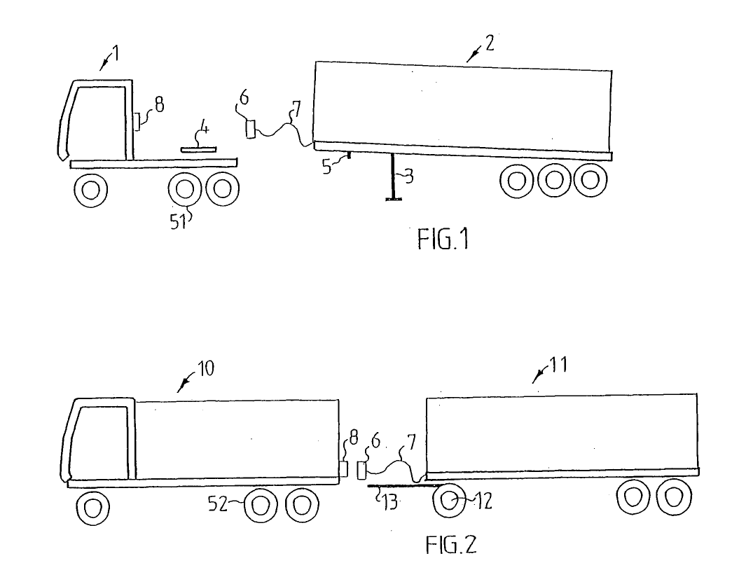

FIG. 2 is a corresponding view of a straight truck with a detached trailer,

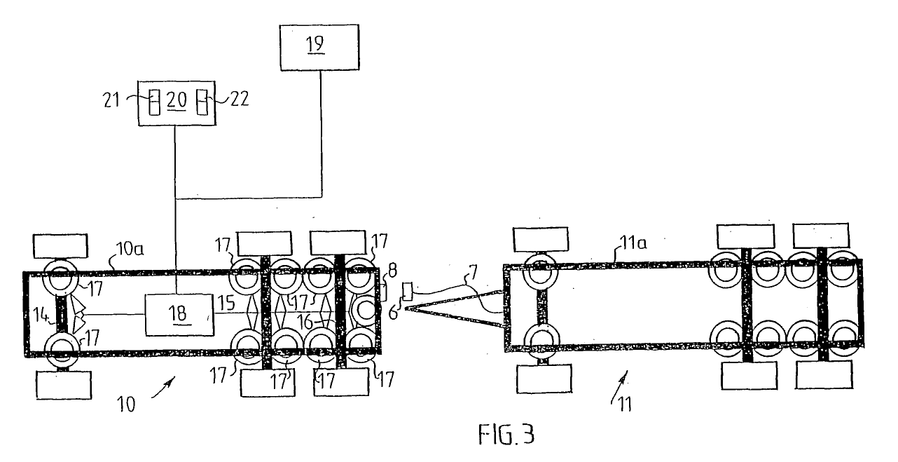

FIG. 3 is a schematic plan view of the rig in FIG. 2,

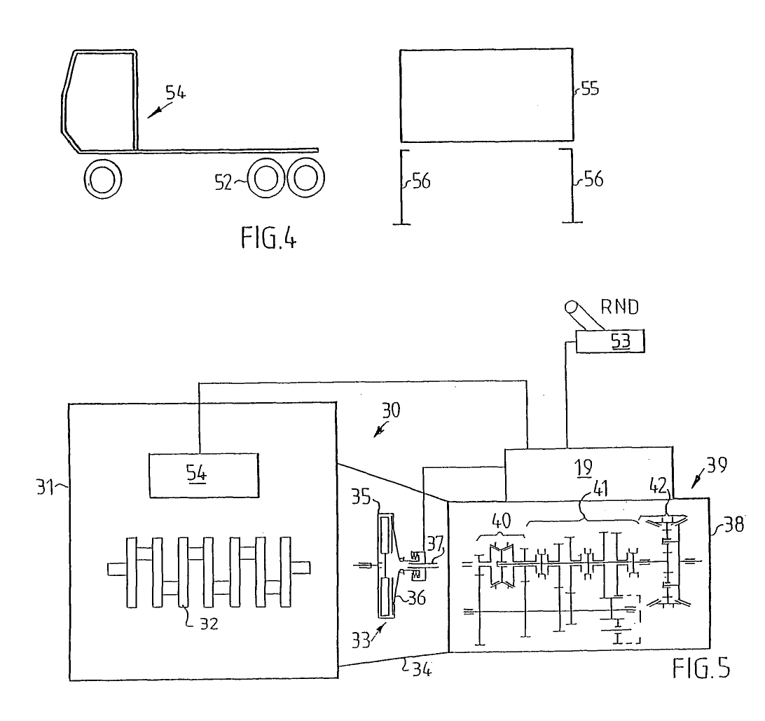

FIG. 4 is a schematic side view of another type of straight truck with a detached load carrier, and

FIG. 5 is a schematic representation of an internal combustion engine with a clutch and gearbox connected thereto.

In FIG. 1, 1 designates a conventional semi-tractor, and 2 designates a conventional semi-trailer, which in FIG. 1 is shown detached from the tractor 1 and is supported on its forward support legs 3. The tractor has a trailer connection or fifth wheel 4, which, when the tractor 1 backs in under the trailer 2, is brought into engagement with a kingpin 5 under the trailer. After engagement of the trailer 2, a connector 6 on an electric cable 7 is plugged into an electrical outlet 8 on the tractor for supplying current to the rear lights, brake lights, side lights, etc. of the trailer 2.

In FIG. 2, 10 designates a straight truck and 11 designates a trailer with a steerable front axle 12, which is jointed to the truck via a pulling shaft 13. FIG. 2 shows the trailer detached from the truck 10. For coupling the trailer 11, the truck is backed towards the trailer so that the pulling shaft 13 can be coupled to a trailer hitch (not shown) on the truck 10. After attachment of the trailer, a corresponding connector 6 on an electrical cable 7 is coupled to an electrical outlet 8 on the truck.

FIG. 3 shows schematically the chassis 10a of the truck 10 and the chassis 11a of the trailer 11 in FIG. 2. The axles 14, 15 and 16 of the truck 10 are in this case suspended on air springs 17, which are coupled to a control unit 18, with the aid of which the pressure in the air chambers of the air springs 17 can be regulated. The control unit 18 for the air springs 17 is coupled to a transmission control unit 19 (see also FIG. 5) and to an operating unit 20, which has a first manual switch 21 which can be switched between a drive position and a height adjustment position and a second manual control 22 for supplying or purging air from the air chambers of the air springs 17. With the switch 21 in the drive position, the operating unit 21 is blocked against manual adjustment of the air springs 17. When the chassis 10a is to be raised or lowered relative to the road surface, the switch 21 is first placed in the height adjustment position, whereafter the air pressure in the air springs can be regulated with the second control 22.

In FIG. 4, another type of straight truck 54 is shown with a detached load carrier 55 supported on supporting legs 56.

FIG. 5 shows a drive unit 30 for the tractor vehicles 1 and 10. The drive unit 30 comprises in the example shown a six cylinder engine 31, e.g. a diesel engine, the crankshaft of which is coupled to a single disc drive disc clutch, generally designated 33, which is enclosed in a clutch cover 34. The crankshaft 32 is non-rotabably joined to the clutch housing 35, while its disc 36 is non-rotatably joined to the input shaft 37, which is rotatably mounted in the housing 38 of a gearbox, generally designated 39, which in the example shown consists of a splitter unit 40, a base unit 41 and a range unit 42. The gearbox 39 drives the drive wheels 51, 52 of the tractor vehicles 1, 10 and 54 and is controlled by the transmission control unit 19 in response, on the one hand, to the position of a manual gear selector 53 and, on the other hand, to various signals fed into the control unit 39 from sensors (not shown in more detail here). The engine 31 is controlled by an electronic engine control unit 54.

The gear selector 53 has a neutral position N and two automatic drive positions D (forward) and R (reverse) and possibly other positions as well, so that the driver can manually select gears. In positions D and R, the transmission control unit 19 selects the gear automatically at start off, and for driving forward and for reversing. In the normal case, the transmission control system 19 selects the starting-off gear in a known manner, i.e. with the aid of information concerning rig weight, road grade, driving resistance, etc. The control unit selects normally a starting-off gear, which sets a limit of circa one second for clutch slippage at a given rig weight and road grade, which can vary. The starting-off gear is determined by a first table (strategy) stored in the control unit 19 as a function of rig weight and road pitch. When starting on flat ground with the trailer attached, the transmission control system 19 can select, for example, first gear in the base unit 41 of the gearbox and high split 40.

In various situations there is a need for the tractor vehicle to start off at a lower gear than what is selected according to said first strategy. This is the case, for example, when the semi-trailer 2 in FIG. 1 is to be decoupled from the semi-tractor 1. To provide good maneuverability when maneuvering the tractor vehicle during detachment of the fifth wheel 4 from the kingpin 5, it is desirable to be able to operate at relatively high rpm at low speed and thus it is more advantageous to have a gear with a higher ratio than first gear, e.g. a crawl gear. For this purpose, according to a first embodiment of the invention, the transmission control unit 19 is disposed to detect detachment of the connector 6 from the electrical outlet 8 on the tractor vehicle and to select a starting-off gear in accordance with another table stored in the control unit 19, which in the example described selects instead a crawl gear or first gear together with low split. The decoupling of the connector 6 from the electrical outlet 8 is thus the step which indirectly indicates that the trailer has been detached. When the vehicle has been driven a certain distance, e.g. ten meters, the control unit is arranged so as to select a gear in accordance with the first table.

When coupling a load carrier 11 or 55 to or from the straight truck in FIGS. 2, 3 and 4, which has air suspension, it is common that these steps will occur together with the adjustment of the air suspension 17 for level adjustment of the chassis 10a relative to the road surface. For level adjustment it is necessary that the switch 21 of the operating unit 20 be in the level adjustment position. This is utilized in a second embodiment of the invention in that the control unit 19 is disposed to select the starting-off gear from the second table when the switch 21 is in the level adjustment position and from the first table when the switch 21 is in the drive position. With this solution, the low gear is automatically selected from the second table even for coupling and decoupling of a load carrier.

In tractor vehicles of the type described with electronic engine and transmission control using a control computer, it is common to store values of the minimum and maximum allowable weights of the tractor vehicle and the minimum and maximum allowable weight of the trailer. During operation the transmission control unit 19 intermittently computes the mass of the vehicle on the basis of extracted engine torque and acceleration and stores the value in the memory. When starting off after stopping with a tractor vehicle 1, 10 with or without a trailer 2, 11, the control unit 19 selects the starting-off gear from the first table on the basis of the last stored value of the rig weight, provided that the control unit has not received information that a change in state has occurred, i.e. no trailer has been coupled or decoupled. When starting off after decoupling of the trailer 2, 11, the control unit is disposed to select the starting-off gear from the second table, starting from the mean value of the stored values of the minimum and maximum weights of the tractor vehicle. When a tractor vehicle 1, 10 without a trailer 2, 11 starts off after stopping, the control unit is disposed, after an indication that a trailer 2, 11 has been coupled to the tractor, to select the starting-off gear from the second table on the basis of the sum of the mean value of the tractor vehicle 1, 10 and the trailer 2, 11. When the rig has been driven far enough that the control unit can compute the actual weight of the rig in accordance with the above, the gear selection is effected from the first table. Typical minimum and maximum values for a semi-tractor 1 can be seven and eight tons, respectively, and for a straight truck 10, ten and twenty-five tons, respectively. Typical minimum and maximum values for a semi-trailer 2 can be ten and twenty-seven tons, respectively, and for a trailer 11, ten and thirty-five tons, respectively.

1. Motor-driven tractor vehicle with an automatic clutch (30) and transmission (39) between the engine and the drive wheels (51, 52) of the vehicle, comprising an electronic control unit (54) for controlling the engine, means (6, 8; 20) which, directly or indirectly, can identify whether a load carrier (2, 11, 55) has been coupled or decoupled, an electronic control unit (19) for controlling the transmission and the clutch depending on the set position of a manual gear selector (53), said control unit being arranged, when the gear selector is in the position for automatic shifting, to select, for starting off, a starting-off gear, which is determined by a first gear selection strategy stored in the control unit on the basis of various control parameters fed into the control unit, characterized in that the transmission control unit (19) is arranged at starting off, at least after the indication that the load carrier (2, 11, 55) has been detached, to select a starting-off gear which is determined by a second gear selection strategy stored in the control unit.

2. Motor-driven tractor vehicle according to claim 1, characterized in that the transmission control unit (19) is arranged, after driving a predetermined distance after the indication that the load carrier (2, 11, 55) has been detached, to select a gear in accordance with the first gear selection strategy.

3. Motor-driven tractor vehicle according to claim 1, with adjustable air suspension (17) and with a manually operated control (20) for controlling the suspension, which can be switched between a first driving position and a second position for adjusting the suspension, characterized in that the transmission control unit (19) is disposed to select the starting-off gear in accordance with the first gear selection strategy when the suspension control is in the first position and in accordance with the second gear selection when the suspension control is in the second position.

4. Motor-driven tractor vehicle according to claim 1 or 2, characterized in that in the transmission control unit (19) there are stored values of the minimum and maximum allowable vehicle weight and minimum and maximum trailer weight, and that the transmission control unit is arranged to control the selection of the starting-off gear in accordance with a first gear selection strategy after indication that the load carrier (2, 11, 55) is attached on the basis of a predetermined value of the combined weight of the tractor vehicle (1, 10) and the load carrier and in accordance with a second gear selection strategy after indication that the load carrier is detached on the basis of a predetermined value of only the weight of the tractor vehicle.

5. Motor-driven tractor vehicle according to claim 4, characterized in that said predetermined values are the mean value of the lowest and highest weight of the tractor vehicle type (1, 10) and the mean value of an unloaded and a maximally loaded load carrier (2, 11, 55).

6. Motor-driven tractor vehicle according to one of claims 1-5, characterized in that the gear selection, in accordance with the second gear selection strategy, includes the selection of a starting-off gear with a higher gear ratio than gear selection in accordance with the first gear selection strategy.
